(19) United States
(12) Patent Application Publication
(10) Pub. No.: US 2026/0121012 A1
(43) Pub. Date: Apr. 30, 2026

(54) Manufacturing method of solid-state electrolyte layers for rechargeable solid-state batteries

(71) Applicant: Yoongu Kim, Lexington, MA (US)

(72) Inventor: Yoongu Kim, Lexington, MA (US)

(21) Appl. No.: 18/928,738

(22) Filed: Oct. 28, 2024

(51) Int. Cl. H01M 4/04; H01M 4/02

(52) U.S. Cl. CPC H01M 4/0407; H01M 4/0471; H01M 2004/021; H01M 2300/0068

(57) ABSTRACT

The present disclosure relates to a manufacturing method of pore-free dense solid-state electrolyte layers for rechargeable solid-state batteries. Using conventional casting methods used in the field of rechargeable batteries, solid-electrolyte-precursor materials are coated on electrodes. In order to manufacture the dense solid-state electrolyte layers, an electron beam is employed to electro-magnetically scan the coated precursor materials with a high speed. The intense electron beam rapidly increases temperatures of the materials with a fast-scanning rate and makes uniform melting of the precursor materials. In this way, the dense solid-state electrolyte layers are manufactured while minimizing thermal damages of electrodes.

### RELATED APPLICATIONS

This application claims benefits under 35 U.S.C. S 119(e) to U.S. Provisional Patent Application Ser. No. 63/548,159 filed on Nov. 10, 2023, which are hereby incorporated by reference in its entirety.

### FIELD OF THE INVENTION

The present invention presents a method for manufacturing solid-state electrolyte layers for rechargeable solid-state batteries.

### BACKGROUND OF INVENTION

Conventional rechargeable Li/Li-ion batteries have been intensively developed toward electric vehicles and consumer electronic devices such as Smart phones, Tablets and Laptops. However, use of liquid electrolytes causes safety issues of the batteries, such as explosions and fires. The batteries also have limitations to enhance their energy density. Demands of rechargeable solid-state batteries are thus highly amplified because the batteries do not include unstable-toxic liquid electrolytes and their energy densities can be potentially higher than those of the conventional rechargeable batteries. However, there are many challenges to manufacture the solid-state batteries consisting of three layers of cathode, electrolyte and anode. Among the battery layers, manufacturing solid-state electrolyte layers is very challenge since the electrolyte layers should satisfy the following conditions; that is, i) high ionic conductivities, ii) high stabilities against anode for long cycle life, iii) high mechanical strengths to prevent Li dendrites against Li anode, iv) thin layers for fast ion transport time and enhancing energy densities, and v) low manufacturing costs.

Currently developments of solid-state electrolytes containing Li or Na have been focused on sulfide-based solid-state electrolytes because the electrolyte layers can be manufactured at low temperatures by conventional mechanical press and have ion conductivities closed to those of conventional liquid electrolytes. However the mechanical pressing methods are not enough to densify the sulfide-based solid-state electrolytes without pores and grain boundaries limiting cycleabilities of the solid-state batteries. In order to synthesize dense glassy sulfide-based electrolyte layers, Visco et al developed a process route combining an extrusion method with high temperature melting. Considering all of the aspects, there are still many technological barriers to overcome. First the sulfide-based electrolytes are degraded when they are contact with anodes of Li and Na. Second their mechanical strengths may not be strong enough to prevent dendrite formations of Li and Na induced by charge/discharge cycles of the batteries. Third mechanical pressing methods may be not enough to create the electrolyte layers without pores and grain boundaries. Fourth the electrolytes can generate toxic H₂S gases in contact with moistures during manufacturing processes and the toxic gases will be very harmful to human and corrosive for manufacturing equipment. Thus, manufacturing the sulfide-based solid-state electrolytes requires careful controls producing high equipment costs.

Unlike the sulfide-based solid-state electrolytes, sintered oxide-based solid-state electrolytes are mechanically strong and relatively stable in contact with anodes of Li and Na. Also the electrolytes do not produce the toxic gases when they contact moistures in manufacturing environments. However after mechanical pressing steps, the oxide-based solid-state electrolytes require high-temperature sintering steps to make the electrolytes mechanically strong and dense. For example, dense oxide-based electrolyte layers are usually prepared by slurry casting methods on electrodes and then co-sintered with the electrodes in a conventional furnace at high temperatures of >1000° C. Due to the high-temperature sintering conditions, electrode layers and current collectors, typically copper and aluminum foils, are degraded. The high sintering temperatures can generate thermal-mismatch stresses between electrode layers and the metal foils causing interfacial delamination. Long sintering time will damage the interfaces between the solid-state electrolyte layers and the electrode layers as well as the metal foils. Thus, the problems said should be overcome to build rechargeable solid-state batteries with the oxide-based solid-state electrolytes.

Rechargeable solid-state thin-film batteries have been manufactured using vacuum deposition methods such as RF-magnetron sputtering, electron-beam deposition, pulsed laser deposition, etc. Among the vacuum deposition methods, RF-magnetron sputtering methods have been used to manufacture the thin-film batteries employing lithium phosphorous oxynitride (Lipon) thin-film electrolytes. Although the Lipon electrolytes do not have high ionic conductivities of ˜10⁻⁶ S/cm, their thicknesses are controlled by 1-2 μm, so lithium ions can have short transport time between cathode and anode. Also the Lipon electrolytes have wide electrochemical voltage window, strong mechanical property, and stability in contact with Li anodes during charge/discharge cycles. The Lipon-based thin-film batteries maintained long cycle life of 10,000 cycles. However the sputtering rates of the Lipon films are around 2 nm/min, so it takes long time to manufacture 1-2 μm film thicknesses. The RF-magnetron sputtering methods also suffer from target racetrack issues which cause low target utilizations. In addition, the RF-magnetron sputtering methods using high-vacuum systems require high-cost capital investments for large area depositions as well as high-cost maintenances.

Recently laser beam and electron beam have been commercially employed in 3D metal printers because the small beam spots can selectively and quickly heat materials to very high temperatures without heating entire process spaces and then create strong bonds between particles. Techniques of electron beam and laser beam have been also employed in various material processes, such as material sintering, surface modifications, material welding, thin film deposition, etc. There were attempts to use the laser beam to synthesize solid-state electrolytes. Oukassi et al used the laser beam to create solid-state electrolyte layers on electrodes for microbattery applications. The crystalline solid-state electrolyte layers, Li_{1.5}Al_{0.5}Ge_{1.5}(PO₄)₃, were be synthesized by applying solid-state electrolyte powders on electrode surfaces followed by pulsed laser sintering steps and then laser recrystallization steps. Recently Jianchao Ye et al also synthesized Li₇La₃Zr₂O₁₂ electrolytes using a laser sintering technique in order to overcome long sintering hours as well as very high temperature sintering of more than 1100° C. used in conventional furnaces. The sintered solid-state electrolytes were very thick and the resulting electrolytes had Li₂CO₃ surface contaminants which may prohibit interfacial ion transportation during charge/discharge cycles of the batteries. The electron beam was used to improve stability and activity of V₂O₅ cathodes synthesized using an electrochemical deposition method. Although both electron beam and laser beam can heat materials, there are differences. First, the electron beam is usually operated in vacuum and thus can create less contaminants on solid-state electrolyte layers than the laser. Second, electron-beam scanning is electro-magnetically controlled while laser beams employ mechanical scanning methods. This aspect indicates that the electron beam can scan material surfaces faster than the laser beam. Thus, the electron beams can potentially melt electrolyte surfaces uniformly compared to the laser beams. Third, because the laser beam absorption depends on materials, the laser will have inefficiency in heating different materials and so different laser sources will be needed to heat the materials. Unlike the laser beam, the electron beam can melt many different materials as reported in electron-beam deposition techniques. Until now, the electron beam has not been employed in manufacturing solid-state electrolyte layers for rechargeable solid-state batteries yet.

### SUMMARY OF THE INVENTION

The present invention provides a method to manufacture solid-state electrolyte layers for rechargeable solid-state batteries. After coating solid-state electrolyte layers onto substrates, conventional manufacturing methods use high temper sintering conditions of >1000° C. as indicated earlier. The current invention manufactures solid-state electrolyte layers by rapidly melting solid-state electrolyte materials using the electron beams. In this aspect, the solid-state electrolyte materials cover substrates prior to electron-beam melting steps. The substrates can be various forms, such as metal foils, polymer sheets, fiber meshes, fabrics, battery separators, electrodes (cathode and anode), solid-electrolyte-coated electrodes, and the like.

In some embodiments, various coating methods can be used to coat the substrates using the solid-state electrolyte materials; such as slot die machine, doctor blade coating, curtain casting, spray coating, inkjet printing, screen printing, solvent-free dry coating, and the like.

In some embodiments, coating materials of solid-state electrolytes can be prepared from powders, powder mixtures, solvent-powder mixtures, and the like.

In some embodiments, sol-gel coating methods can be used to create solid-state electrolyte layers and coating materials can be selected from chemical precursors of oxide-based, sulfide-based, oxysulfide-based, halide-based solid-state electrolytes. The selected precursors are mixed with solvents prior to coating steps.

In some embodiments, powder mixtures and solvent-precursor mixtures can employ binders to hold powder particles or improve coating adhesion on substrates. After process steps of coating and drying are completed, a pressing tool, such as roll pressing, can be employed to compact the coating layers prior to electron-beam heating steps.

In some embodiments, the solvents in the coating layers can be dried in an oven prior to electron-beam heating steps. The binders used can be removed in an oven prior to electron-beam heating steps.

In some embodiments, multiple electron-beam guns can be used to improve manufacturing throughput and uniformities of solid-state electrolyte layers.

In some embodiments, gases of He, O₂, N₂, and Ar or the gas mixtures can be introduced to remove gases evolved from the melt pools of solid-state electrolyte layers during the electron-beam heating steps.

In some embodiments, crystal structures of the solid-state electrolyte layers can be amorphous, crystalline or semi-crystalline. The solid-state electrolyte layers can be oxide-based, sulfide-based, oxysulfide-based, halide-based solid-state electrolytes.

### BRIEF DESCRIPTION OF THE DRAWINGS

FIG. 1 is a flow diagram of manufacturing solid-state electrolyte layers from powder mixtures.

FIG. 2 is a flow diagram of manufacturing solid-state electrolyte layers from solution mixtures.

FIG. 3 shows schematic diagram where electron beam is applied to manufacture solid-state electrolyte layers on electrode layers.

FIG. 4 shows photo of a) electron beam melting of Li₃PO₄ solid electrolyte and b) surface of Li₃PO₄ after electron beam melting.

FIG. 5 Electrochemical impedance spectroscopy (EIS) of Li₃PO₄ layer

### DETAILED DESCRIPTION OF THE INVENTION

The present invention provides a manufacturing method of solid-state electrolyte layers using electron beam. Manufacturing dense solid-state electrolyte layers requires electron-beam techniques rapidly melting solid-state electrolyte powders, powder mixtures of solid-state electrolytes or solution precursor mixtures casted on substrates. After the electron beam rapidly melts mixtures of solid-state electrolytes casted on substrates, the melted mixtures are quickly solidified and converted into solid-state electrolyte layers. The substrates are, but not limited to, various forms, such as metal foils, polymer sheets, fiber meshes, fabrics, battery separators, electrodes (cathode and anode), solid-electrolyte-coated electrodes, and the like.

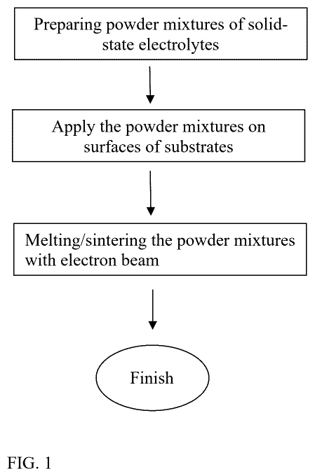

FIG. 1 shows the flow diagram of making solid-state electrolyte layers using solid-state electrolyte powders. First powder mixtures of solid-state electrolytes are prepared. Second the powder mixtures are applied onto substrates using the coating method mentioned earlier. Third the powder-coated substrates are transferred into a processing chamber and then electron beam rapidly scans surfaces of the powder mixtures where the power mixtures are melted and converted into solid-state electrolyte layers.

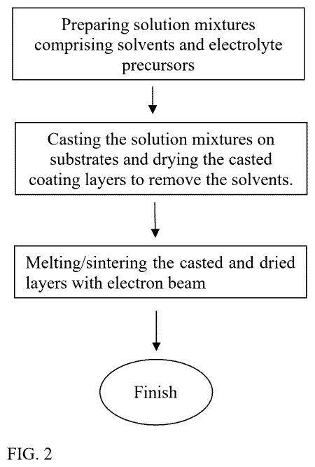

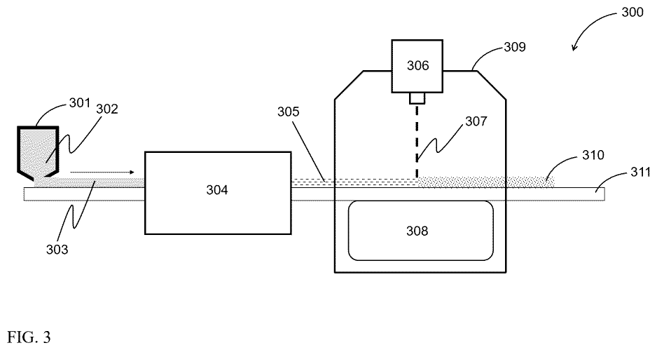

In certain embodiment, the solid-state electrolyte layers can be manufactured from solution mixtures. The mixtures will contain solid-state electrolyte powders, binders and solvents. FIG. 2 shows the flow diagram of making solid-state electrolyte layers using solution mixtures. In order to manufacture solid-state electrolyte layers, first solution mixtures of solid-state electrolytes are prepared. Depending on properties of solutions, additives can be added to stabilize the solutions; such as, surfactants and plasticizers. After thoroughly mixing the solution mixtures, the solution mixtures are transferred into a coating container 301 and then are casted onto substrates 311 as shown in FIG. 3. After drying step in a dry oven 304 is completed, the casted electrolyte mixtures on the substrates are continuously transferred into a vacuum chamber 309. When the electrolyte mixtures are arrived near an electron beam gun 306, electron beam 307 will scan the dried electrolyte mixtures 305 in FIG. 3 to melt and then convert them into solid-state electrolyte layers 310. The electron-beam sintering steps will create crystalline solid-state electrolyte layers. A cold chuck or a heater 308 can be used to control substrate temperatures while the electron beam scans the solid-state electrolyte layers for melting and sintering.

In certain embodiment, the solution mixtures said are applied onto the substrates using various coating methods; such as slot die machine, doctor blade coating, curtain casting, spray coating, inkjet printing, screen printing, and the like.

In certain embodiment, the various solid-state electrolyte powders can be used to manufacture solid-state electrolyte layers. The powder's chemical formulae can be, but not limited to, Aₓ[M_{χ}¹M_{ε}²M_{γ}³ . . . M_{η}ⁿ]_{δ}O_{y}, Aₓ[M_{χ}¹M_{ε}²M_{γ}³ . . . M_{η}ⁿ]_{δ}O_{y}X_{z}, A[M_{χ}¹M_{ε}²M_{γ}³ . . . M_{η}ⁿ]₂(PO₄)₃, A_{1+x+y}Alₓ(Ti,Ge)₂₋ₓSi_{y}P_{3-y}O₁₂, garnet-type solid electrolytes (i.e. A₇La₃Zr₂O₁₂), Ohara solid electrolytes (i.e. A₂O—Al₂O₃—SiO₂—P₂O₅—TiO₂), alkali metal halides (i.e. Aₓ[M_{χ}¹M_{ε}²M_{γ}³ . . . M_{η}ⁿ]_{δ}X_{y}) . . . etc. where A=Li or Na, Mⁿ (n=1-10)=B, C, Al, P, Si, As, Ga, Ge, In, Se, Sc, Ti, V, Zn, Y, Zr, Nb, Mo, La, Sn, Er, Yb, X═N, F, Cl, Br, I, Se, and x=0.1-20, y=0.1-20, δ (δ=χ+ε+γ . . . +η)=1-10, and z=0.01-10.

In certain embodiment, the electrolytes containing sulfur can be used to manufacture glassy electrolyte layers; such as Aₓ[M_{χ}¹M_{ε}²M_{γ}³ . . . M_{η}ⁿ]_{δ}S_{w}, Aₓ[M_{χ}¹M_{ε}²M_{γ}³ . . . M_{η}ⁿ]_{δ}S_{w}X_{z}, Aₓ[M_{χ}¹M_{ε}²M_{γ}³ . . . M_{η}ⁿ]_{δ}O_{y}S_{w} and Aₓ[M_{χ}¹M_{ε}²M_{γ}³ . . . M_{η}ⁿ]_{δ}O_{y}S_{w}X_{z} where A=Li or Na, Mⁿ (n=1-10)=B, C, Al, P, Si, As, Ga, Ge, In, Se, Sc, Ti, V, Zn, Y, Zr, Nb, Mo, La, Sn, Er, Yb, X═N, F, Cl, Br, I, Se, and x=0.1-20, y=0.1-20, δ (δ=χ+ε+γ . . . +η)=1-10, z=0.01-10, and w=0.01-20.

In certain embodiment, binders can be added to improve wetting of layers and control colloidal sizes and can be selected, but not limited to, from Polyvinylidene fluoride (PVDF), Polyvinyl alcohol (PVA), Polyvinyl butyral (PVB), Polyvinylpyrrolidone (PVP), Poly(ethylene oxide) (PEO), Poly-methyl methacrylate (PMMA), Polytetrafluoroethylene (PTFE), linear, branched, or cross-linked polymers, and the like.

In certain embodiment, the solvents can be selected, but not limited to, from H₂O, Methanol, Ethanol, Acetone, Isopropanol, Hexane, Diethyl carbonate (DEC), Dimethyl carbonate (DMC), Dimethyl sulfoxide (DMSO), Dimethylformamide (DMF), Ethylene carbonate (EC), Methyl ethyl carbonate (MEC), N-Methylformamide (NMF), N-Methyl-2-pyrrolidone (NMP), Propylene carbonate (PC), Tetrahydrofuran (THF), Acetonitrile, Dimethoxyethane (DME), carbon-containing organic solvents, and the like.

In certain embodiment, the solid-state electrolyte layers can be prepared using sol-gel coating methods with various chemical precursors. Before manufacturing the solid-state electrolyte layers, chemical precursors of the solid-state electrolytes are dissolved into an appropriate solvent and the mixtures are casted onto substrates. The chemical precursors are, but not limited to, metal alkoxides, metal acetates, metal carbonates, metal hydroxides, metal halides, inorganic acids (such as H₃PO₄, H₃PO₃, H₄SiO₄, and the like), A₂CO₃, AClO₃, ABrO₃, ANO₃, AlO₃, AₓX, MₓO_{y}, MₓS_{y}, and S where A=Li or Na, M=B, Al, P, Si, As, Ga, Ge, In, Se, Ti, V, Zn, Y, Zr, Nb, Mo, La, In, Sn, X═O, S, F, Cl, Br, I, Se, x=0.1-10, and y=0.1-10.

In certain embodiments, the solid-state electrolyte layers can be created from combinations of solid-state electrolyte powders and sol-gel precursors.

In certain embodiments, nitrogen can be incorporated into crystal structures of the solid-state electrolytes by adding nitride compounds, such as M^{I}ₓM^{II}_{y}N_{z} (x=0.0-5, y=0.0-5, and z=0.01-5), into the electrolyte powders or electrolyte precursors prior to electron beam melting steps. Here M^{I} and M^{II} are Li, Na, B, Al, P, Si, As, Ga, Ge, In, Se, Ti, V, Zn, Zr, Nb, and Mo. Also, ammonia gases, NH₃, can be used to incorporate nitrogen into crystal structures of the electrolytes during the electron beam scanning because the gases react with melted solid-state electrolytes.

In certain embodiment, multiple coating steps of solid-state electrolytes in either the same compositions or the different compositions can be applied onto the substrates.

In certain embodiment, solid-state electrolyte mixtures are coated on front and backsides of substrates and two electron beam guns are used to manufacture solid-state electrolyte layers on the both surfaces.

In certain embodiment, surfaces of the crystalline solid-state electrolyte layers can be remelted to create amorphous surface layers making uniform ion transport through interfaces between solid-state electrolytes and anodes.

In certain embodiment, thin solid-state electrolyte layers of <2 μm as interfacial layers can be applied onto electrode surfaces (i.e., cathode and anode) to improve stabilities in conventional rechargeable Li/Li-ion batteries employing liquid electrolytes.

In certain embodiment, multiple electron beam guns are utilized to increase manufacturing throughput of the coating layers.

In certain embodiment, while the electron beam scans mixture surfaces of either powders or solutions, either one of He, O₂, N₂, and Ar or the gas mixtures can be introduced into the vacuum chamber. The flowing gases quickly remove gas species from the heated coating mixtures, and minimize surface contaminants of solid-state electrolyte layers.

### EXAMPLES

### Example 1

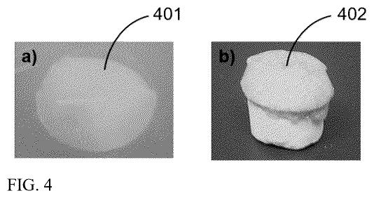

FIG. 4a shows melted surface of Li₃PO₄ solid-state electrolyte when electron beam power of 110 W/cm² was applied on the area of ˜5.0 cm². Li₃PO₄ melting point is about 1206° C. If conventional furnaces are used, all of electrolyte-coated electrodes will be heated to the high temperature and then sintered for a long time. So the high-temperature sintering will degrade other electrode components as well as interfaces between solid-state electrolytes and electrodes. However, as shown in FIG. 4a, if the electron beam is used, it could locally and rapidly melt Li₃PO₄ surfaces 401 with minimum substrate heating and the melted surfaces of Li₃PO₄ were visually uniform due to fast beam scanning. Once the electron beam scanning stops, the uniformly-melted Li₃PO₄ were quickly solidified with the very smooth surface 402 as shown in FIG. 4b. In these aspects, the electron beam techniques can highly minimize the issues mentioned in the conventional furnace sintering methods.

### Example 2

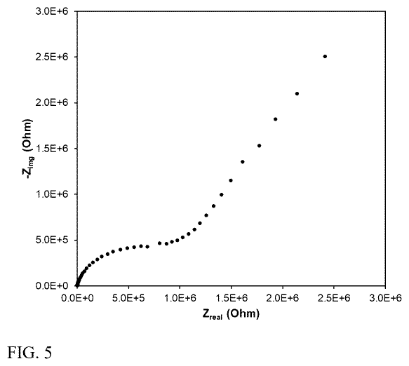

Li₃PO₄ electrolyte layer was prepared using electron beam combined with solution method. Precursors were lithium oxide: Li₂O and phosphoric acid: H₃PO₄. The precursors were added into DI water with a molar ratio and mixed well by a stirring bar. This electrolyte solution was casted on surface of a stainless-steel foil and dried to remove H₂O in an oven. Electron beam scanned the dried precursor mixture. Ionic conductivity was measured using electrochemical impedance spectroscopy (EIS) after metal electrodes were created on the electrolyte surfaces using a sputter deposition method. FIG. 5 shows EIS result of Li₃PO₄ layers. The layer thickness was about 3 μm and calculated ionic conductivity was 1.5E-8 S/cm.

The disclosure herein of any particular feature, aspect, method, property, characteristic, quality, attribute, element, or the like in connections with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A method of manufacturing solid-state electrolyte layers for rechargeable solid-state batteries, the method comprising:
providing coating mixtures comprising powders of solid-state electrolytes, chemical precursors of solid-state electrolytes, polymer binders, and solvents;
providing substrates comprising either no layers or layers comprised of electrode layers of cathode or anode, said substrate of a size, shape, thickness and/or form-factor suitable for use as electrodes of cathode and anode;
casting the mixtures onto the substrates using coating methods comprising doctor-blade coating, screen printing, slot-die coating, curtain coating, spray coating, ink-jet printing, screen printing, solvent-free dry coating, and the like; and
electron beams melt and sinter the coated layers where the solid-state electrolyte layers are amorphous, crystalline, and semi-crystalline.

2. The method of claim 1, wherein multiples of electron beam guns can be used to increase manufacturing throughput and uniformity of solid-state electrolyte layers.

3. The method of claim 1, wherein the vacuum pressure range of the electron beam chamber is 1×10⁻⁷-760 Torr.

4. The method of claim 1, wherein a cold chuck (or heater) can be used to control substrate temperatures while electron beam scans the solid-state electrolyte layers for melting and sintering.

5. The method of claim 1, wherein when electron beam irradiates the powder mixtures and the solution mixtures, either gases (such as He, O₂, N₂, Ar, and the like) or the gas mixtures can be introduced into the vacuum chamber to quickly remove gas species evolved from the heated coating mixtures and minimize surface contaminants of solid-state electrolyte layers.

6. The methods of claim 1, wherein solid-state electrolyte mixtures are coated on front and backsides of substrate surfaces, so at least two electron beam guns can be used to manufacture solid-state electrolyte layers on the both substrate surfaces.

7. The method of claim 1, wherein the solid-state electrolyte layers are prepared from either solid-state electrolyte powders or powder mixtures comprising components of solid-state electrolytes.

8. The method of claim 7, wherein solid-state electrolyte powders can be, but not limited to, Aₓ[M_{χ}¹M_{ε}²M_{γ}³ . . . M_{η}ⁿ]_{δ}O_{y}, Aₓ[M_{χ}¹M_{ε}²M_{γ}³ . . . M_{η}ⁿ]_{δ}O_{y}X_{z}, A[M_{χ}¹M_{ε}²M_{γ}³ . . . M_{η}ⁿ]₂(PO₄)₃, A_{1+x+y}Alₓ(Ti,Ge)₂₋ₓSi_{y}P_{3-y}O₁₂, garnet-type solid electrolytes (i.e. A₇La₃Zr₂O₁₂), Ohara solid electrolytes (i.e. A₂O—Al₂O₃—SiO₂—P₂O₅—TiO₂), alkali metal halides (i.e. Aₓ[M_{χ}¹M_{ε}²M_{γ}³ . . . M_{η}ⁿ]_{δ}X_{y}) . . . , etc. where A=Li or Na, Mⁿ (n=1-10)=B, C, Al, P, Si, As, Ga, Ge, In, Se, Sc, Ti, V, Zn, Y, Zr, Nb, Mo, La, Sn, Er, Yb, X═N, F, Cl, Br, I, Se, and x=0.1-20, y=0.1-20, δ (δ=χ+ε+γ . . . +_{η})=1-10, and z=0.01-10.

9. The method of claim 7, wherein the electrolytes containing sulfur can be used with the following chemical formulae; that is, Aₓ[M_{χ}¹M_{ε}²M_{γ}³ . . . M_{η}ⁿ]_{δ}S_{w}, Aₓ[M_{χ}¹M_{ε}²M_{γ}³ . . . M_{η}ⁿ]_{δ}S_{w}X_{z}, Aₓ[M_{χ}¹M_{ε}²M_{γ}³ . . . M_{η}ⁿ]δO_{y}S_{w} and Aₓ[M_{χ}¹M_{ε}²M_{γ}³ . . . M_{η}ⁿ]_{δ}O_{y}S_{w}X_{z} where A=Li or Na, Mⁿ (n=1-10)=B, C, Al, P, Si, As, Ga, Ge, In, Se, Sc, Ti, V, Zn, Y, Zr, Nb, Mo, La, Sn, Er, Yb, X═N, F, Cl, Br, I, Se, and x=0.1-20, y=0.1-20, δ (δ=χ+ε+γ . . . +η)=1-10, z=0.01-10, and w=0.01-20.

10. The method of claim 1, wherein the solid-state electrolyte layers are prepared from the following solution mixtures; i) electrolyte powers+binders+solvents, ii) electrolyte precursors+electrolyte powers+binders+solvents, iii) electrolyte precursors+solvents, iv) electrolyte precursors+binders+solvents, and the like where surfactants can be added to control layer wetting properties.

11. The method of claim 10, wherein the chemical precursors of the solid-state electrolytes will be, but not limited to, metal alkoxides, metal acetates, metal carbonates, metal hydroxides, metal halides, inorganic acids (such as H₃PO₄, H₃PO₃, H₄SiO₄ and the like), A₂CO₃, AClO₃, ABrO₃, ANO₃, AlO₃, AₓX, MₓO_{y}, MₓS_{y}, and S where A=Li or Na, M=B, Al, P, Si, As, Ga, Ge, In, Se, Ti, V, Zn, Y, Zr, Nb, Mo, La, In, Sn, X═O, S, F, Cl, Br, I, Se, x=0.1-10, and y=0.1-10.

12. The method of claim 1, wherein the solvents can be selected, but not limited to, from H₂O, Methanol, Ethanol, Acetone, Isopropanol, Hexane, Diethyl carbonate (DEC), Dimethyl carbonate (DMC), Dimethyl sulfoxide (DMSO), Dimethylformamide (DMF), Ethylene carbonate (EC), Methyl ethyl carbonate (MEC), N-Methylformamide (NMF), N-Methyl-2-pyrrolidonc (NMP), Propylene carbonate (PC), Tetrahydrofuran (THF), Acetonitrile, Dimethoxyethane (DME), carbon-containing organic solvents, and the like.

13. The method of claim 7, wherein nitrogen can be incorporated into the solid-state electrolytes by adding nitride compounds, such as M^{I}ₓM^{II}_{y}N_{z} (x=0.0-5, y=0.0-5, and z=0.01-5), into either the electrolyte powders or electrolyte precursors prior to use of electron beam. Here M^{I} and M^{II} are Li, Na, B, Al, P, Si, As, Ga, Ge, In, Se, Ti, V, Zn, Zr, Nb, and Mo.

14. The method of claim 7, wherein nitrogen can be incorporated into crystal structures of the solid-state electrolytes by flowing ammonia gases into process chamber while the electron beam scans the powder mixtures or the solution mixtures.

15. The method of claim 1, wherein multilayers of the solid-state electrolytes can be created by multiple castings of the solid-state electrolyte mixtures followed by melting/sintering processes of electron beam.

16. The method of claim 15, wherein the multi-casted solid-state electrolyte layers can have different chemical compositions and crystal structures.

17. The methods of claim 1, wherein thin solid-state electrolyte layers of <2 μm can be applied onto electrode surfaces (i.e., cathode and anode) as interfacial layers to increase battery stabilities of conventional rechargeable Li/Li-ion batteries.

18. The methods of claim 1, wherein the solid-state electrolyte layers can be created on membranes of polymer, graphene, graphene oxide, fiber, carbon fiber, and the like.

19. The method of claim 1, wherein surfaces of the crystalline solid-state electrolyte layers can be remelted to create amorphous surface layers making uniform ion transport through interfaces between electrolytes and anodes.

20. The method of claim 1, wherein thicknesses of the solid-state electrolyte layers are 0.1-50 μm.
